(19) United States
(12) Patent Application Publication
(10) Pub. No.: US 2007/0165574 A1
(43) Pub. Date: Jul. 19, 2007

(54) METHOD AND APPARATUS TO MINIMIZE PACKET LOSS DURING ACTIVE DATA HARD HANDOFF

(75) Inventors: Lena Srey, Carpentersville, IL (US); Gordon Annan, Algonquin, IL (US); Kent M. Conness, Downers Grove, IL (US); Brian A. Hansche, Gilbert, AZ (US); Javed A. Khan, Chandler, AZ (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/620,763

(22) Filed: Jan. 8, 2007

Related U.S. Application Data
(60) Provisional application No. 60/758,748, filed on Jan. 13, 2006.

(51) Int. Cl. H04Q 7/00

(52) U.S. Cl. 370/331

(57) ABSTRACT

A method of hard handoffs begins by establishing a wireless link between a source radio access network (102a) and a mobile station (106). When the mobile station moves into another adjacent radio access network (102b), the present invention detects that handoff of the link from the source to the target is necessary. Additional data is not sent to the mobile station from the source radio access network. The data that has not been received by the mobile station is stored or buffered. A disconnect message is received by the source and a connect message is received by the target so that an active handoff is achieved between the source and the target. When the active handoff procedure is complete the data that was buffered by the source BTS as not being received by the mobile station is then sent to the active target cell such that data and packet loss is reduced.

### FIELD OF THE INVENTION

The present invention relates generally to active hard handoffs in wireless communication systems and, in particular, to a method and apparatus to minimizing data loss by buffering data.

### BACKGROUND

Wireless communication networks and systems cover wide areas of territory and often configured of numerous smaller areas commonly called radio access networks or cells. Each sector includes the necessary hardware elements to effectuate wireless communications within that cell. As such, each cell includes at least a base transceiver site (BTS) that serves as the hardware element within the cell to transmit to and receive data from other cells and for forwarding and receiving the data to mobile stations that are within the cell. Each cell can also include a base station controller (BSC) that controls the operation of the BTS. It is understood by those of ordinary skill in the art that a BSC can be a part of the wireless communication network's core network and therefore control the BTSs for more than one cell.

When a mobile station moves from one radio access network to another radio access network, control of the mobile station moves from the BSC, BTS and other network hardware elements from the first radio access network, known as the source, to the second radio access network, known as the target. This process of transferring the mobile station from a source to a target is known as handoff or hand over. A mobile station may be handed off from a source to a target when there is no active data transfer occurring between a BTS and the mobile station. This occurs when a mobile station is moving from cell to cell while waiting for a data or voice call to be sent to the mobile station or initiated by the mobile station. It is also possible that the mobile station needs to be handed off to a target when data is being actively transferred between the BTS and the mobile. This occurs during an active call while the mobile station moves from one cell to another cell.

Wireless communication networks and systems operate with different types of handoffs depending on the different type of network as well as the needs of the connection between the mobile station and the BTS and other hardware elements. Hard handoff occurs when there the hardware of the target cell takes control of the handoff when the source terminates control and there is minimal interaction between the source and target. Hard handoff presents numerous problems, including the loss of data that can, at least in part, be addressed by soft and softer handoff. In soft and softer handoff, the source and target hardware equipment transfer data and communicate with one another during the handoff process in such a way that the source and target take steps to lessen the likelihood that data is lost during the handoff process. Nonetheless, while soft and softer handoffs provide improvements over hard handoff, there are situations where hard handoffs are required or provide the necessary level of service in the network.

While active hard handoffs, which occur when a mobile station is in a call, the data loss that happens in the course of the call have different effects in voice and data calls, where the loss of data in the data call may be more profound in the data call then the voice call. During active data hard handoff, data buffered at the selector distribution unit (SEL) or other hardware component of the source cell may be lost. As data is lost from the old cell, the target SEL, or comparable hardware component, will note that the data received for the mobile station is corrupted and the lost data will have to be resent from the source cell or from the originating source of the data. This process can cause additional data loss and may cause an unacceptable disruption to delay-sensitive services such as push-to-talk calls or Voice over Internet Protocol (IP) calls. For example, in various types of compression technology, including Van Jacobson compression, the lost data may be headers such as TCP/IP headers which can be equal to the TCP Receive Window Size. If the TCP Receive Window Size is set to 32,000 bytes, then all data in the window will be corrupted by the lost data, and there will be a need to retransmit all the 32,000 bytes of data.

Before active handoff is initiated, data is being sent between BTS and the mobile station. Some of the data is actively being sent from the BTS to the mobile while some of the data is still held in buffers at the BTSs. When active handoff is initiated, there will be data in both the buffers and between the BTS and the mobile station. This data cannot be considered to be received by the mobile station when the active handoff is completed and the disconnect message from the source cell is received and the connect message for the target cell is received. This data that BTS believes to have been sent to the mobile station, being either in the air or in the buffer, is lost. During active handoff this data can be discarded as being considered sent, even though it has not been received.

As can be seen from the foregoing, there is a need within active hard handoffs to prevent data loss and to prevent the data being discarded that is believed to be sent to a mobile station which has not been received by the mobile.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a block diagram of a wireless communication network that is utilizes some embodiments of the present invention.

FIG. 2 is a block diagram of a mobile station during an active hard handoff in accordance with some embodiments of the present invention.

FIG. 3 is a flow chart of the active hard handoff of the embodiment shown in FIG. 2.

FIG. 4 is another block diagram of a mobile station during an active hard handoff in accordance with some embodiments of the present invention.

FIG. 5 is a flow chart of the active hard handoff of the embodiment shown in FIG. 4.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

In order to reduce the loss of data during active hard handoffs presented in the prior art, the present invention provides a method of hard handoffs within a wireless communication network that begins by establishing a connection or wireless link between a base transceiver site or station and a mobile station while the mobile station is within a source radio access network. With the wireless link, there is active communications between the BTS and the mobile station such that the BTS sends data to the mobile station in the forward link and the mobile station sends data to the BTS in the reverse link. When the mobile station moves into another adjacent radio access network, the present invention detects that a wireless link, including the forward and reverse links, between the mobile station and the source BTS needs to be actively handed off to the BTS and other hardware components of the adjacent radio access network. When the active handoff is detected, the present invention stops sending data from the BTS to the mobile station. The data that is being sent from the source BTS to the mobile station is stored or buffered. The data that is being buffered includes that data that has been sent by the BTS and is in progress of being received by the mobile station as well as data that has not been sent by the BTS and is stored by the BTS. A disconnect message is received by the source BTS and a connect message is received by the target BTS in a manner known by those of ordinary skill in the art such that an active handoff is achieved between the source and the target. When the active handoff procedure is complete the data that was buffered by the source BTS as not being received by the mobile station is then sent to the active target cell such that data and packet loss is reduced.

The present invention includes an apparatus within the wireless communication network that effectuates active hard handoffs from a first radio access network to a second radio access network within the wireless communication network. The apparatus includes a first interface that connects to a mobile station that can move between a source radio access network and a target radio access network within the wireless communication network. The apparatus also includes a second interface that connects the apparatus with the target radio access network. The apparatus and the second interface are configured to minimize data loss during an active handoff of a call to the mobile station between the source radio access network and the target radio access network. The apparatus detects when an active hard handoff from the source to the target is going to occur. After detection of such a handoff, the apparatus stores data that has been sent from the network to the source radio access network but has not yet been sent to the mobile station while in the source radio access network. Such data can be stored in buffers on the apparatus or on other network hardware devices. Once the data is stored, the active hard handover is effectuated when the mobile station is within the target radio access network. The stored or buffered data is then sent from its stored location within the source radio access network to the radio access network station, which is in the target radio access network. Data transfer can then resume between to the mobile station and the target radio access network with minimal data loss. As described in further detail below, the second interface can be a part of a tunnel between the source cell and the target radio access network and through which the data buffered in the source radio access network is sent to the target radio access network after the active hard handoff is completed.

The wireless communication network of the present invention includes a source cell where an active call with a mobile station is operational. A target cell is also a part of the network and is adjacent to the source cell such that the mobile station can move between the source and the target cells. Both the source and target cells include the necessary hardware equipment to conduct wireless communications including but not limited to, base transceiver stations, base station controllers, packet control functions and selection distribution units. The network can also include core network equipment such as a packet data switching node that services the source and target cells and can reside with either, both or neither of the cells. When the mobile station moves from the source cell to the target cell an active hard handoff is detected and at which time the source base station stops sending data within the source cell. Data being sent to the mobile from the hardware within the source cell, including the source BTS, is stored or buffered within the source cell. The wireless communication network then effectuates the active hard handoff when the mobile station is in the target cell. Once the mobile station is within the target cell and the active hard handoff is complete, the source cell transferred the stored and buffered data to the target. In an embodiment of the wireless communication network, the data is sent from the source packet control function and selection distribution unit to the packet switching data node and then to the target packet control function and selection distribution unit.

Before describing in detail embodiments that are in accordance with the present invention, it should be observed that the embodiments reside primarily in combinations of method steps and apparatus components related to reducing packet and data loss during active hard handoff in a wireless communication network. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of the method and apparatus that minimizes packet and data loss during hard handoffs as described herein. The non-processor circuits may include, but are not limited to, a radio receiver, a radio transmitter, signal drivers, clock circuits, power source circuits, and user input devices. As such, these functions may be interpreted as steps of a method to perform the methods that reduce the data loss during hard handoffs. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

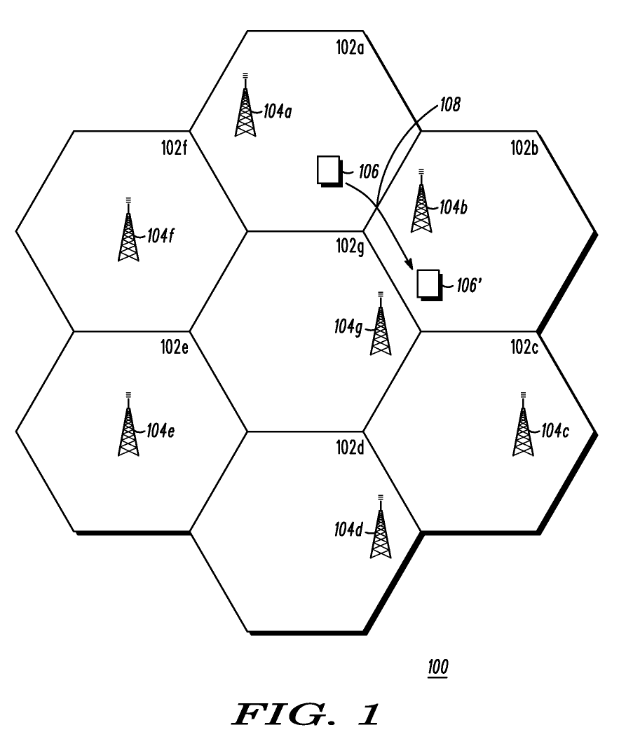

Turning to FIG. 1, a wireless communication network and system 100 used in connection with embodiments of the present invention is shown. Network 100 can be any of a variety of different wireless communication systems currently being used and under development including code division multiple access (CDMA), global system of mobile communication (GSM), universal telecommunication mobile system (UTMS), and Voice over IP networks. In a preferred embodiment, the present invention is designed for CDMA type networks include those that operate under IS-95, IS-2000, wide band CDMA and any future CDMA standards based technologies.

The wireless communication network 100 is divided into multiple radio access networks or cells 102a-g such that each cell covers a given area. As seen in the Figure, cell 102a is adjacent to cells 102b, 102f and 102g. Cell 102b is adjacent to cells 102a, 102g, and 102c. The other cells are likewise adjacent to multiple cells such that the network 100 covers a given territory. Within each cell 102a-g, there are certain hardware components that are necessary to conduct the wireless communications. These hardware components include, but are not limited to a base transceiver site or station (BTS) 104a-g such that each cell 102a-g includes its own BTS 104a-g. A BTS 104a transmits and receives data to a mobile station 106 that is within the cell. Each mobile station 106 includes a transceiver and controller (not shown) so that the mobile station transmits and receives data with the BTS 104a as is known to those of skill in the art. As is understood, the mobile station can move between cells such that the mobile station 106 starts in source cell 102a and moves along line 108 so that mobile station 106′ is in adjacent target cell 102b. When is in adjacent target cell 102b, BTS 104b transmits and receives data from mobile station 106′.

Active data handoffs occur when a mobile station 106 moves from source cell 102a to a target cell 102b source while there is active data transfer between the source BTS 102a and to the mobile station 106. The source BTS 104a receives a disconnect message when it is ready to send a handoff direction to the mobile station 106 to execute the hard handoff. When the disconnect message is received, the BTS 104a or another component within the source cell 102a begins to buffer user traffic data. Such buffered data may include data that was received earlier from the BTS and which has not yet be transmitted to the mobile as well as data waiting to be delivered to the source BTS 104a. When the active hard handoff is completed and the mobile station 106′ connects to the target BTS 104b, the data buffered at the source BTS is lost or discarded since there is no existing mechanism to allow the buffered data to be transferred to the target BTS 104b. This may have undesirable effects on the performance of the certain application such as Van Jacobson compression. In the present invention, however, the data that is not received by the mobile station 106 is sent to the mobile station 106′ when the active hard handoff is completed. The data that is buffered includes that data that is still within the BTS 104a that has not yet been transmitted to the mobile station 106.

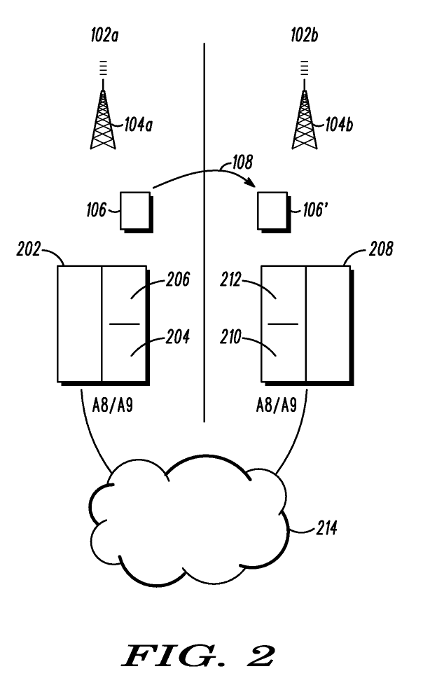

FIG. 2 illustrates an embodiment of the present invention. Both the source cell 102a of a first radio access network and the target cell 102b of a second radio access network include a base station controller (BSC) 202, 204, respectively. As known by those of skill in the art, the BSCs 202, 204 operate in conjunction with the BTSs 104a, 104b, respectively, so as to transmit to and receive data from the mobile station 106/106′. It is also known that while BSCs 202, 204 are shown, the network 100 can be configured such that one BSC can be a part of a core network so as to service multiple cells 102a-g and multiple BTSs 104a-g. In some embodiments of CDMA technology, including CDMA2000, the BSC 202, 204 include a packet control function (PCF) 204, 210, respectively, and a selection distribution unit (SEL) 206, 212, respectively. The packet control function 204, 210 communicate through an A8/A9 interface with the selection distribution unit (SEL) 206, 212 respectively.

The core network of the wireless communication network includes a packet switching data node (PDSN) 214. The function of the PDSN is known by those of skill in the art. PDSN 214 includes an A10/A11 connection with both the source BSC 202 and the target BSC 208 wherein GRE packets are sent over the A10/A11 connections. In an embodiment of the present invention, the A10/A11 connection is made between the PDSN 214 and the source PCF 204 as well as between the PDSN 214 and target PCF 210.

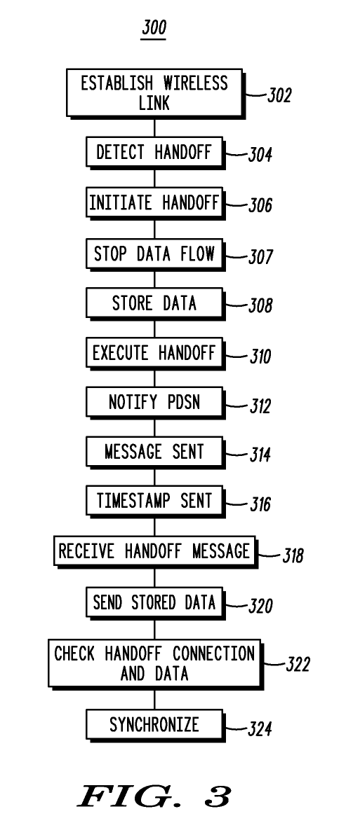

FIG. 3 is a flow diagram of the operation 300 of the present invention's embodiment shown in FIG. 2. The active hard handoff of the present invention occurs when a wireless communication link is established 302 between the mobile station and a source radio access network. The source radio access network includes, but is not limited, to the source cell 102a, BTS 104a and the source BSC 202 with its PCF 204 and SEL 206. The radio access network detects 304 that handoff of the wireless connection to an adjacent target radio access network because the mobile station 106 is about to move or has moved into the adjacent radio access network or for other known reasons. The target radio access network includes, but is not limited to, the target cell 102b, target BTS 104b, and the target BSC 208 with its PCF 210 and SEL 212. In the event that the mobile station 106 is in an active call and the mobile station is relocated into the target radio access network, the source BSC 202 initiates 306 an active hard handoff to the target radio access network.

In order to complete the active hard handoff, the BSC 202 instructs the source PCF 204 to stop 307 sending data to the mobile station 106. In the embodiment of CDMA2000, the PCF 204 stops sending radio link protocol (RLP) data. After the PCF 204 has stopped sending data, the PCF 204 stores 308 data that has not been received by the mobile station 106. The data may be stored by the BSC 202 in any number locations known by those of skill in the art including a buffer within the PCF 204. The data is stored with detailed information regarding its nature, e.g., details about location within the sequence of data being transferred and other types of identifying information. The SEL 206 executes 310 an RLP active hard handoff using the detail information about the stored data. As a part of the active hard handoff, the SEL notifies 312 the PDSN 214 via the A10/A11 to start sending GRE packets and data to the target PCF according to a known make-before-break topology. As is known, a send handoff direction message is sent 314 to the mobile station 106 and a handoff direction message timestamp is sent 316 to the target BSC 104b for explicit extended supplemental channel assignment message (ESCAM).

At the target radio access network, the target BSC 104b receives 318 notification that active hard handoff of the mobile station 106′ is to be conducted. Once the handoff is completed, the PDSN 214 forwards 320 the target BSC 208, and in particular, the target PCF 210 the buffered data and GRE over the A10/A11 interface. The detail information regarding the buffered data is included in with the buffered information. The target radio access network uses the detail information to check 322 the buffered data received and ensure that it is accurately sent and used.

In the event that PDSN bi-casting is enable, the active target BSC 208 selector (not shown) will synchronize 324 with the source BSC 202 selector (not shown) and perform selection and distribution of packets for the handoff. Thus, the system avoids sending replicated data to the mobile station 106.

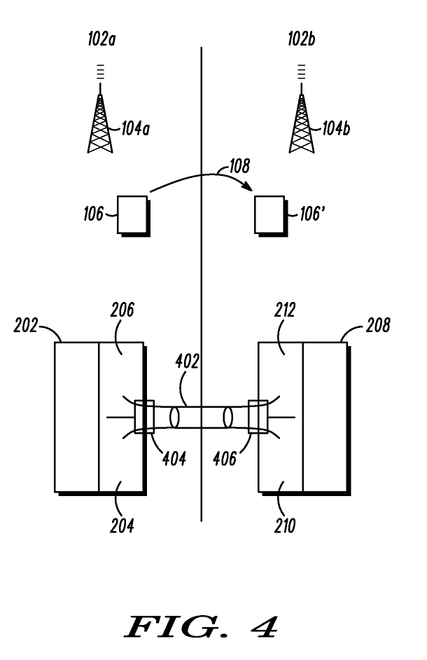

FIG. 4 illustrates another embodiment of the present invention. Instead of using the PDSN within the core network to provide the buffered data to the target radio access network, this embodiment utilizes a tunnel 402 that is created between the source radio access network and the target radio access network. The tunnel 402 is a fast connection on-demand virtual tunnel that connects the source PCF 204 with the target PCF 210 and the source SEL 206 with the target SEL 212. As will be appreciated, an interface 404, 406 at both the source radio access network and the target radio access network, respectively, is needed to form the tunnel 402. As a part of establishing the tunnel 402, the source radio access network has a first interface 404 while the target radio access network has a second interface has a second interface 406. The tunnel 402 connects the source and target using the first and second interfaces 404, 406.

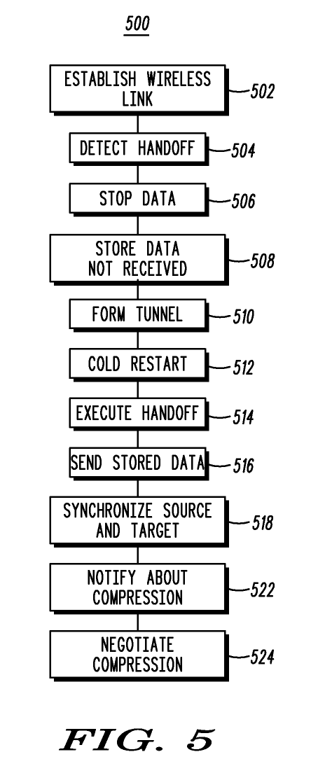

FIG. 5 is a flow diagram of the operation 500 of the present invention's embodiment shown in FIG. 4. The active hard handoff of the present invention begins when a wireless communication link is established 502 between the mobile station and a source radio access network. The source radio access network 102a detects 504 that an active hard handoff is required for the wireless connection to an adjacent target radio access network 102b.

In order to complete the active hard handoff, the BSC 202 instructs the source PCF 204 to stop 506 sending data to the mobile station 106 such as stopping the PCF 204 from sending radio link protocol (RLP) data. After the PCF 204 has stopped sending data, the PCF 204 stores 508 data that has not been received by the mobile station 106. The data is stored or buffered by the BSC 202 or other known location. The data that is stored and buffered is the data that the BSC 202 considers to have been sent to the mobile by the BTS 104a and has not been received by the mobile station 106. The data is stored with the detailed information described above. As a part of the active hard handoff process, the source PCF 204 and source SEL 206 form 510 the tunnel 402 with the target PCF 210 and target SEL 212. As described above, the tunnel 402 is found between the first and second interfaces 404, 406.

At the target radio access network, a cold restart 512 of the targets RLP state machine is needed when the tunnel 402 is created. Once the tunnel is created, the active hard handoff is executed 514 so that the target radio access network can take control of the link to the mobile station 106′. The target PCF 210 and SEL 210 receive 516 the buffered data, which may includes RLP data and GRE packets that would have been sent through the PDSN 214, through the tunnel 402. In an embodiment of the present invention, a connection can be established with the PDSN 214 such that data from the PDSN 214 is also sent to the target radio access network as a part of the active hard handoff. When the buffered information has been received, the mobile station 106′ is synchronized 518 with the target radio access network. A handoff completion message can be used as a part of the synchronization. If Van Jacobson compression is active, then the target PCF 210 notifies 522 the PDSN 214 to negotiate 524 to have compression turned on.

An embodiment of the present invention uses a packet redirection scheme as described for active hard handoffs. A GRE frame is used as a part of the active hard handoff. The GRE packet includes a type field that identifies the type of the attribute. The length field identifies the length of the value field, and the value field contains information specific to the attribute. If the GRE packet is to be redirected from the source radio access network to the target radio access network through the PDSN 214 or tunnel 402, the type field contains a specific reference to a redirected packet. In addition, the value field will indicate the type of buffering and redirection that will be used, e.g. via PDSN 214, tunnel 402, combination of the two or otherwise.

The packet redirection feature allows the source PCF 204, during an inter PCF active data hard handoff, to redirect user data buffered at the PCF that has not been transmitted to the mobile or even redirected packets received from the source BTS. At the option of the PCF 204 and if allowed by the PDSN 214, this buffered user data may be redirected to the target PCF via the PDSN 214 during inter PCF hard handoff. Alternatively, the user data may be redirected to the target radio access network via tunnel 402. Upon receiving a redirected GRE frame, the target PCF 210 may place the buffered or encapsulated user traffic data ahead of any normal user traffic data received at the target PF from the target PDSN. This enables the target PCF to send user traffic in sequence to the target BTS, if desired. The redirected user data may be sent in an unstructured byte stream type GRE frame on the A8 interface to the target radio access network.

The packet redirection feature also allows the source radio access network during an intra-PCF active data hard handoff to redirect user data buffered at the source radio access network that has not yet be transferred to the mobile station 106. At the option of the source radio access network and if allowed by the PCF, this buffered user data may be redirected to the target radio access network via the PCF. Upon receiving a redirected GRE frame, the PCF may place the encapsulated user traffic data ahead of any normal user traffic data received at the PCF from the PDSN or the tunnel 402. This enables the PCF to send user traffic in sequence to the target radio access network and BTS 104b if desired. The redirected user data is sent in a GRE frame on the A8 interface to the target BS.

The redirection of GRE packets during active hard handoffs via PDSNs is enabled by the PDSN during the registration procedure for a packet data service instance. The PDSN enables this feature by including an indicator in the A11 registration reply message. The PDSN may use service options received in the A11 registration request message to determine if packet redirection should be enabled or disabled. If the PDSN indicates that it enabled packet redirection for the corresponding A10 connection, the source PCF may, during active hard handoffs, send buffered GRE frames received earlier from the PDSN and which have not yet been sent to the mobile station or even redirected GRE frames received from the source radio access network, to the target PCF 210 via the PDSN or the tunnel. This redirected GRE frames are sent with an attribute included in the frame and associated with packet redirection.

As can be appreciated, there are numerous benefits to the process of buffering data that is considered sent to the mobile station before an active hard handoff is started where that data has not been received by the mobile station. The embodiments described above minimize packet loss during active hard handoff due to the RLP reestablishments or restarts caused by missing data. This missing data is identified by the present invention by the detail information described above. In some embodiments, including those involving compression technologies, TCP retransmissions are reduced due to packet loss caused by the amount of data loss within a TCP window size. TCP retransmissions are also reduced that can impact the applications running over the active link between the mobile station 106/106′ and the source and target radio access networks. In push-to-talk environments, the present invention also reduces the RLP re-start delay because there is reduction in the likelihood of missing data after the active hard handoff.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. A method of handoff in a wireless communication system comprising:
detecting that a wireless link between a mobile station and a first radio access network is to be handed off to a second radio access network;
stopping sending data to the mobile station from the first radio access network;
buffering data not received by the mobile station from the first radio access network;
handing off the wireless link from the first radio access network to the second radio access network, and
transferring data buffered in the buffering data step to the mobile station after the handing off the wireless link step is completed.

2. The method of claim 1 further comprising establishing a tunnel between the first radio access network and the second radio access network for transferring data buffered in the buffering data step.

3. The method of claim 2 wherein the first radio access network has a first interface to the tunnel and the second radio access network has a second interface to the tunnel.

4. The method of claim 1 wherein the transferring data buffered in the buffering data step comprising:
establishing a first link between a source packet control function of the first radio access network and a packet data switching node, and
establishing a second link between the packet data switching node and a target packet control function of the second radio access network,
wherein the transferring data buffered in the buffering data step is transferred via the first link and the second link.

5. The method of claim 1 further comprising assigning detail information to the data buffered in the buffering step wherein the detail information for transferring the buffered data in the transferring step.

6. The method of claim 1 wherein the wireless communication system is a code division multiple access system.

7. The method of claim 1 wherein handoff is an active hard handoff.

8. An apparatus in a wireless communication network for handoffs from a first radio access network to a second radio access network, the apparatus comprising:
a first interface to connect to a mobile station when the mobile station is in the first radio access network, and
a second interface to connect with the second radio access network,
wherein the apparatus detects when the mobile station moves from the first radio access network to the second radio access network such a handoff to the second radio access network is necessary and stores data sent by the first radio access network but not received by he mobile station during an active call and transfers the stored data not received by the mobile station to the mobile station after handoff is completed when the mobile station is in the second radio access network.

9. The apparatus of claim 8 wherein the second interface connects the first radio access network to a packet data switching node to transfer data so that the buffered data is sent through the packet data switching node after the handoff is complete.

10. The apparatus of claim 8 wherein the second interface connects the first radio access network to a tunnel and the tunnel connect to the second radio access network.

11. The apparatus of claim 8 further comprising a packet control function and a selection distribution unit.

12. The apparatus of claim 8 wherein the data buffered includes detail information identifying the buffered data.

13. A wireless communication network comprising:
a first radio access network wherein a mobile station can make a connection to the wireless communication network through the first radio access network;
a second radio access network where the mobile station can make a connection to the wireless communication network when the mobile station moves from the first radio access network, and
an interface between the first radio access network and the second radio access network,
wherein the first radio access network stores data that has sent to the mobile station by not received by the mobile station when the connection of the mobile station to the first radio access network is detected to be handed off to the second radio access network and wherein the stored data is transferred from the first radio access network to the second radio access network through the interface after the transfer of the mobile station from the first radio access to the second radio access network is completed.

14. The network of claim 13 wherein the interface connects the first radio access network to a packet data switching node.

15. The network of claim 13 wherein the interface connects the first radio interface to a tunnel that also connects to the second radio access network.

16. The network of claim 13 wherein the wireless communication network is a CDMA2000 network.

17. The network of claim 13 wherein the stored data includes detail information for transferring the buffered data in the transferring step.

18. The network of claim 13 wherein the first radio access network comprises a base transceiver station and base station controller and the second radio access network comprise a base transceiver station.

19. The network of claim 18 wherein the first radio access network further comprises a first packet control function and a first selection distribution unit and the second radio access network further comprises a second packet control function and a second selection distribution unit.
